(19) United States
(12) Patent Application Publication
(10) Pub. No.: US 2003/0140156 A1
(43) Pub. Date: Jul. 24, 2003

(54) Method and apparatus for broadcasting world wide web content

(75) Inventor: Ron Karim, San Jose, CA (US)

Correspondence Address: Attention: PATENT OPERATIONS MANAGER, Sun Microsystems, Inc., 901 San Antonio Road, M/S UPAL01-521, Palo Alto, CA, 94303, US

(73) Assignee: Sun Microsystems, Inc.

(21) Appl. No.: 10/052,067

(22) Filed: Jan. 18, 2002

(51) Int. Cl. G06F 15/16

(52) U.S. Cl. 709/231; 709/203

(57) ABSTRACT

Methods, systems, and articles of manufacture consistent with the present invention broadcast World Wide Web content to permit efficient data retrieval by a large number of users. A data request is initially received from a client data processing device. It is first determined whether the requested data is transmitted via a continuous broadcast loop. The continuous broadcast loop comprises one or more data point continuously transmitted in order from a start data point to an end data point. The requested data is retrieved by opening a connection to the continuous broadcast loop, reading the requested data from the broadcast loop, and transmitting the requested data to the client data processing device.

### BACKGROUND OF THE INVENTION

1. Field of the Invention

The present invention relates generally to data processing systems, and more particularly to methods, systems, and products for broadcasting web content.

2. Description of Related Art

In communication networks, a user who is, for example, operating a client data processing device, may access various kinds of information that is stored remotely at a server data processing device, which is located at an arbitrary location. The information can be stored, for example, at a data providing server connected to a network, such as the Internet.

The information that is available for access by the user may comprise, for example, text information, image information, video information, or audio information. Communications protocols such as the HyperText Transfer Protocol (HTTP) may be employed to transfer the information from the server to the client.

The information may be presented to the user by generating a web page at the server data processing deice and transmitting display contents to the user for local display. A web page is a piece of information that may be stored at a data server and that may be accessed through a network by a user operating a client data processing device. The user could, for example, specify an address or URL (Uniform Resource Locator) of a particular web page on the network and retrieve the corresponding information using a browser program. URLs may be used to access web pages that provide the same information to each user request, without making any distinctions as to the user making the request. Alternatively, dynamically generated web pages may be created containing information specifically generated for the user requesting the information.

Electronic files corresponding to well-known URLs receive many thousands of data requests, or hits, per day. Such URLs may be used to access information specifically generated for the requesting user. For example, a user may enter the URL to an online bookseller using a browser program, which then uses the URL to retrieve data from the Internet, and displays a web page greeting the user by name and providing the user with a list of recommended books

However, the same information may often be provided to each user requesting information located at a given URL. For example, a URL corresponding to an online publication of a periodical or newspaper, or a URL providing general information about a particular topic may provide the same or similar information to each requesting user, with little or no individually tailored information.

Nonetheless, the web server data processing device processes each data request received individually. The server data processing device must execute a retrieval operation for each data request received. For each data request received, the server data processing device must also perform the processing needed to prepare the data for transmission to the requesting user, and then actually transmitting the data.

Thus, executing a data retrieval operation results in costs for CPU cycles and network latency. Executing many data retrieval operations for the same data at the same location multiplies these processing and network latency costs. The effect of these processing and network latency costs is intensified when the server must respond to multiple, asynchronous, “out-of-band” demands for data by users. For example, when a large number of users simultaneously request the same document located at the same URL, each user could potentially experience significant delays in retrieving requested data, since the server hosting the requested data must process each user request individually. In particular, the server must execute the same operations for each user request to access and retrieve the requested data. This results in many duplicate access and retrieval operations being executed, particularly for web content that is continuously presented.

Thus, a mechanism for reducing inefficient access to web content is needed to eliminate the execution of duplicate processing operations at the server data processing device caused by repeatedly retrieving the same data. Minimizing the number of duplicate processing operations may in turn reduce the processing time needed to complete each user request.

### SUMMARY OF THE INVENTION

According to one embodiment of the present invention, there is provided a computer-implemented method for broadcasting World Wide Web content data providing a user with requested data. One embodiment of this invention utilizes a broadcast mechanism to broadcast data in a continuous loop. A user requesting the broadcasted data establishes a connection to the broadcast to retrieve the data, thus reducing the need to execute a separate operation to retrieve the requested data from a storage medium for each user request.

The method includes opening a connection to a continuous broadcast of the World Wide Web content data, reading the content data and reassembling the content data for display by the user's browser client program.

In one embodiment, the method includes:

receiving a data request from a client data processing device;

determining whether the requested data is transmitted via a first continuous broadcast loop, wherein the continuous broadcast loop includes one or more data points continuously transmitted in order from a start data point to an end data point;

retrieving the requested data, wherein if the requested data is transmitted via a first continuous broadcast loop, retrieving the requested data comprises

opening a use connection to the first continuous broadcast loop;

receiving a complete data transmission from the first continuous broadcast loop;

closing the use connection to the first continuous broadcast loop; and

transmitting the requested data to the client data processing device.

Herein, a continuous broadcast loop means World Wide Web content (e.g. HTML data) that is continuously streamed in a repeated serial transmission onto a port using TCP/IP or other well known network protocol.

A further implementation of the present invention provides a computer system for broadcasting World Wide Web content data providing a user with requested data, the computer system comprising a memory for storing a World Wide Web content request processing module, and a processing unit for carrying out receiving a data request from a client data processing device, determining whether the requested data is transmitted via a first continuous broadcast loop comprising one or more data points continuously transmitted in order from a start data point to an end data point, and retrieving the requested data, wherein if the requested data is transmitted via a first continuous broadcast loop, retrieving the requested data comprises opening a use connection to the first continuous broadcast loop, receiving a complete data transmission from the first continuous broadcast loop, closing the use connection to the first continuous broadcast loop, and transmitting the requested data to the client data processing device.

A still further implementation of the present invention may be realized by a computer program for broadcasting World Wide Web content data providing a user with requested data, the computer program comprising computer code for receiving a data request from a client data processing device, determining whether the requested data is transmitted via a first continuous broadcast loop, comprising one or more data points continuously transmitted in order from a start data point to an end data point, and retrieving the requested data. In the operation of retrieving the requested data, if the requested data is transmitted via a first continuous broadcast loop, retrieving the requested data comprises opening a use connection to the first continuous broadcast loop, receiving a complete data transmission from the first continuous broadcast loop, closing the use connection to the first continuous broadcast loop, and transmitting the requested data to the client data processing device.

A program code may be embodied in any form of computer program product. A computer program product comprises a medium which stores or transports computer-readable code, or in which computer-readable code can be embedded. Some examples of computer program products are CD-ROM or DVD-ROM disks, ROM chips, floppy disks, magnetic tapes, computer hard drives, servers on a network and signals transmitted over the network representing a computer-readable program code.

The above-mentioned and other features, utilities, and advantages of the invention will become apparent from the following detailed description of the invention together with the accompanying drawings.

Other systems, methods, features and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of the specification, illustrate an implementation of the invention and, together with the description, serve to explain the advantages and principles of the invention. In the drawings,

FIG. 1 is a block diagram of a client-server data processing system with which embodiments of the broadcast module, request and content processing module, and the request broker of the present invention may be implemented;

FIG. 2 is a process flow for one embodiment of the request broker of FIG. 1;

FIG. 3 is a process flow for one embodiment of a content broadcast loop executed by the broadcast module and accessed by the request and content processing module of FIG. 1;

FIG. 4 is a process flow for another embodiment of the request and content processing module of FIG. 1;

FIG. 5 is a process flow for one embodiment of a request and content processing module of FIG. 7;

FIG. 6 is a process flow for one embodiment of a plugin content and processing module of FIG. 7; and

FIG. 7 is a block diagram for another embodiment of client-server data processing system with which embodiments of the broadcast content processing module of the present invention may be implemented.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

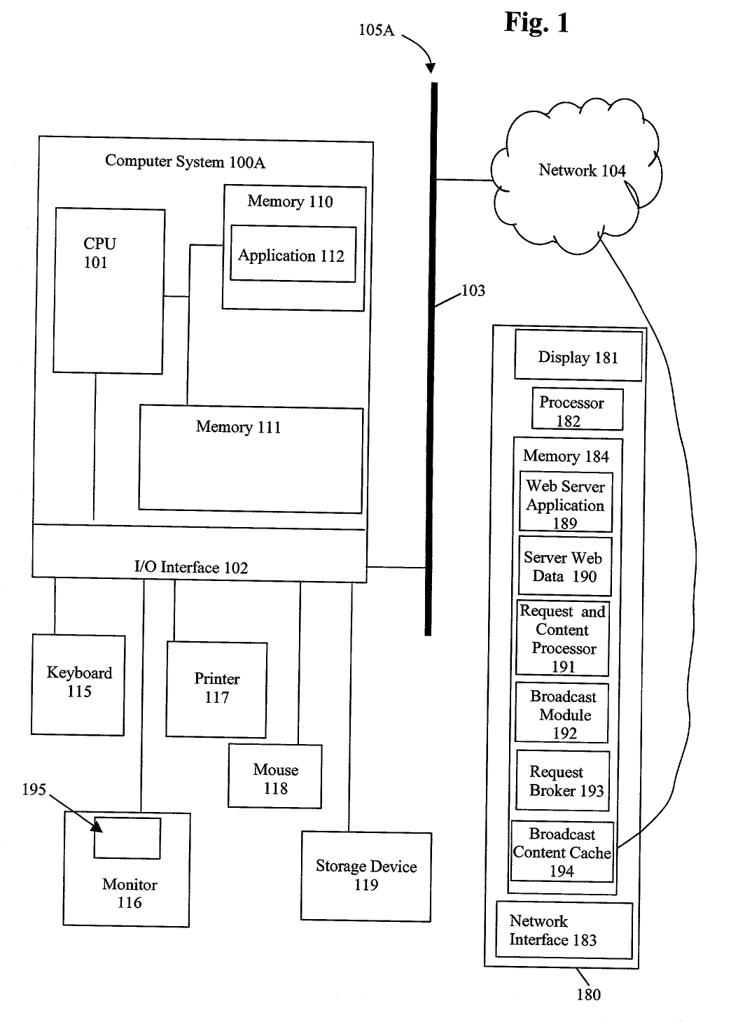

With reference to FIG. 1, there is shown a functional block diagram of a client-server data processing system in which one embodiment of the present invention may be implemented. As shown, in one embodiment of the present invention, a server data processing device 180 may include a broadcast module 192 associated with web server application 189 that continuously broadcasts server web data 190 that may be frequently requested.

Server data processing device 180 also includes a request broker 193 and a request and content processor 191. Server web application 189 receives a data request from a client computer system 100A via network 104, e.g. an HTTP request for content to be displayed in a browser window. This request may be received by request broker 193, which will determine whether to service this request using broadcast server web data or non-broadcast server web data. Server web application 189 may invoke request and content processor 191 to retrieve broadcast web data. Server web application 189 then responds to the data request by transmitting server web data 190 to client computer system 100A.

At the client computer system 100A, a computer based application 112, e.g. a browser program, executing on CPU 101 of computer system 100A may display content, e.g. server web data 190, requested by the user from the remotely located web server 180. This content is transmitted back to the user via network 104. The content may be displayed in window 195 which is displayed on display unit 216, as part of the execution of the browser client application 112.

In FIG. 1, web server application 189, request and content processor 191, broadcast module 192, and request broker 193 are all stored in a memory 184 of a server 180 and executed on server 180 that is coupled to client computer system 100A by networks 103 and 104. The particular type and configuration of server data processing device 180 and client computer system 100A is not essential to this embodiment of the present invention. The only requirement is that the server computer 180 be able to receive and process client requests for both broadcast and non-broadcast web data. Conversely, the client device should be able to receive and display server web data 190, or HTTP and/or web page content, as described herein. Similarly, networks 103 and 104 can be any network or network system that is of interest to a user that couples client computer system 100A to server 180.

Similarly, the methods used to receive user data requests at the client device 100A, to transmit user data requests to the server computer 180, to receive user data requests at the server computer 180, and to display requested server web data at the client is illustrative only and is not intended to limit the invention to the particular embodiments described herein. Finally, server web application 189, request and content processor 191, broadcast module 192, and request broker 193 are illustrated as being separate modules. Again, this is illustrative only. Each of the modules 189, 191, 192, and 193 may be separate and distinct program modules or they may be combined into one or more applications, e.g. modules 191, 192, and 193 may be included in web server application 189. Each of the modules 189, 191, 192, and 193 need only to be able to communicate with the other modules. Similarly, server web data 190 and broadcast content cache 194 may be stored in separate and distinct memory modules or memory segments, or they may be combined into one memory module or segment. Server web data 190 and data in broadcast content cache 194 need only be accessible to program modules 189-193.

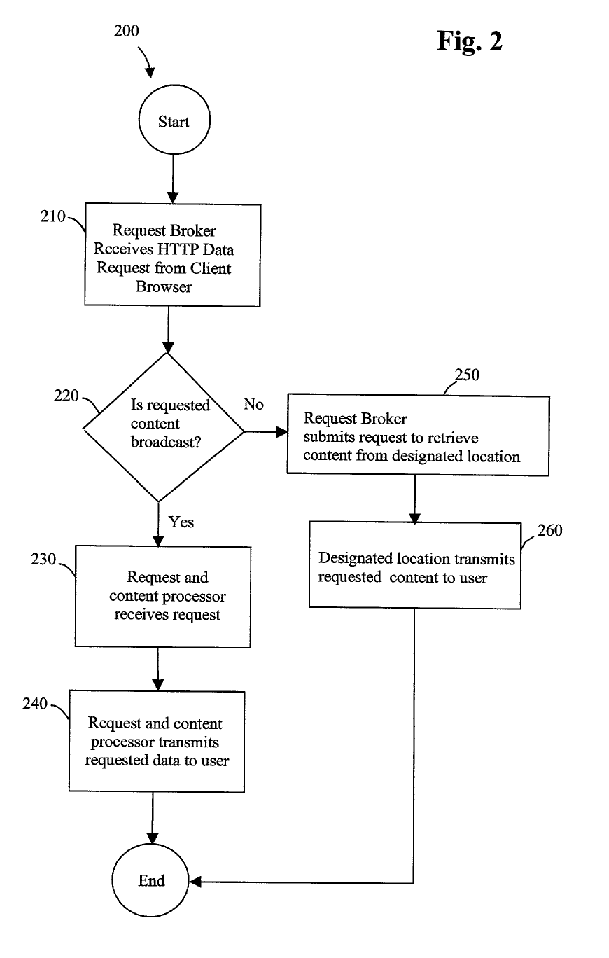

FIG. 2 is a process flow diagram for an embodiment of a method 200 that is executed at the server computer 180 upon receiving a data request from a user. The sequence of operations in method 200 is illustrative only and is not intended to limit the invention to the specific sequence shown. As is known to those of skill in the art, events can be initiated by any of a plurality of users at various points in time and when an event occurs, an event handler processes the event and branches to the appropriate location in method 200. For example, an HTTP data request can be received at any point in time by request broker 193, and the request and content processor 191 can initiate transmission of broadcast data to a user at any point in time. Request broker 193 and request and content processor 191 may also process any number of user requests at a given point in time.

The request broker 193 at the server computer 180 generally waits for a HTTP data request from a client, e.g. client computer 100A, communicating with server computer 180 via network 103 and network 104. When the HTTP data request is received at receive HTTP data request operation 210, the request broker determines whether the requested content is broadcast content, in broadcast content check operation 220.

Broadcast content check operation 220 may examine the address of the data requested by the client, e.g. the URL, in order to determine whether the requested content is broadcast content. Generally, one or more levels of content may be broadcast at server computer 180. Each level of content may be individually represented by a URL or other data address or data locator and may comprise a discrete segment of data, e.g. a web page, that may be displayed to a user. In one embodiment of the invention, each broadcast content level may comprise continuous broadcast content loops, wherein each loop may comprise an activated TCP/IP broadcast function call. The data of the broadcast content level is continuously broadcast at a specified location, e.g. a specific port number. The continuously broadcast data may comprise transmitting the data serially, from the beginning to end, repeatedly and without interruption. In one embodiment of the invention, the broadcast content levels are arranged in a hierarchical order, wherein each broadcast content level or loop represents a level of depth in a web page. In this embodiment, clicking on any hypertext in a given level will transfer the user to a connection with a different broadcast content level or loop.

Addresses of broadcast content may be stored in a lookup table or other data structure in order to make an efficient comparison. Alternatively, the data available at server computer 180 may comprise broadcast data only, in which case broadcast content check operation 220 may be omitted, and request broker 193 may proceed to transmit the data request to request and content processor 191.

Request and content processor 191 receives the data request in broadcast content request receive operation 230. Upon receipt of the data request, request and content processor 191 may determine which of the available broadcast content levels contains the information requested by the user. The determination of which broadcast content level corresponds to the user request may be accomplished using a lookup table containing the addresses (e.g. URLs) of the broadcast content, wherein each address is associated with a port number.

Once the appropriate broadcast content loop or level has been identified as containing the data requested by the user, request and content processor 191 initiates transmission of the requested data in broadcast content transmission operation 240. In one embodiment of the invention, request and content processor 191 will initiate transmission of the requested data at a initial access point, or start data point, on the broadcast content loop, and will continue transmission until the end data point, usually the initial access point is again encountered. At this time, the transmission is considered complete and the transmission is terminated at the initial access point, which also comprises the end data point of the transmission.

However, if the requested content is determined not to be transmitted in a broadcast content loop in broadcast content check operation 220, request broker 193 submits a request to retrieve the non-broadcast content from a designated location in non-broadcast content retrieval operation 250. The designated location may comprise a memory or other storage location containing the non-broadcast content, e.g. server web data 190 in memory 184 located on server computer 180. Alternatively, the designated location may comprise a memory or other storage location containing non-broadcast content located on a remotely located server. Once the non-broadcast content has been retrieved, the content is transmitted to the requested user at client 100A in non-broadcast content transmission operation 260. Non-broadcast content retrieval operation 250 and non-broadcast content transmission operation 260 may be accomplished using the conventional HTTP web server data access and transmission operations known to those of skill in the art, and set forth in APACHE: THE DEFINITIVE GUIDE, 2^{nd} Edition, by Ben Laurie and Peter Laurie (O'Reilly and Associates, February 1999, ISBN 1-56592-5289).

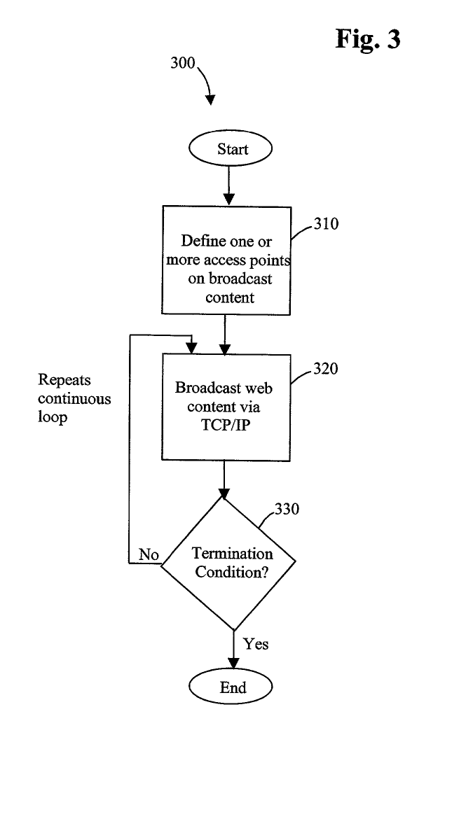

According to one embodiment of the present invention, broadcast content request receive operation 230 will initiate access of the requested data on a broadcast content loop as described above. A broadcast content loop is a continuously executing piece of code that transmits the broadcast content data continuously on a specified port. In one embodiment of the invention shown in FIG. 3, the broadcast content loop is shown as broadcast module 192 included in memory 184 of server computer 180. Preferably, the broadcast content data transmission may be accomplished using a broadcast function call available in TCP/IP and known to those of skill in the art. FIG. 3 shows a process flow diagram of a method 300 for creating and initiating execution of a broadcast content loop.

In one embodiment of the invention, once content data (e.g. in the form of binary code representations of web pages or other computer readable documents displayable at a client device) has been identified for broadcast, one or more access points on the data are defined in define access points operation 310. In onde embodiment of the invention, these access points may be defined at various points in the binary code representations of the broadcast data. The points where access points are defined may be distributed at regular intervals in the data segment to be broadcasted. However, other distributions of access points may be contemplated, e.g. at points between chapters or sections. Each access point may serve as a start data point and/or an end data point for a broadcast transmission. In one embodiment of the invention, an access point may be identified, e.g. as a flag bit, bit segment or index, or code, e.g. in the header of TCP/IP packets used in the broadcast transmission.

Once the access points have been defined, the content is broadcast in broadcast content operation 320. This broadcast is continuous; that is, the entire broadcast is repeated once complete, unless a termination condition has been satisfied, in which case the broadcast may terminate at termination condition check operation 330. A termination condition may include, for example, an automatic expiration of broadcast content after a specified period of time for content that has become outdated, or the termination of a web server application program 189 that is associated with the broadcast module 192, e.g. for scheduled or emergency maintenance. Upon expiration of the content of the broadcast content loop, the termination condition may be fulfilled and the execution of the broadcast content loop may be terminated. New content to replace the expired content may be broadcast continuously by execution of the TCP/IP broadcast call at the same port, using the new content.

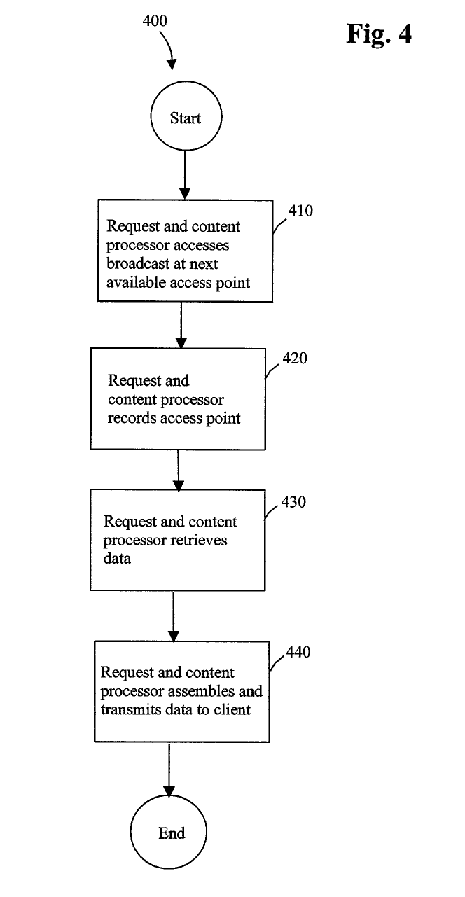

The operation of the request and content processor 191 to receive broadcast content requests and transmit broadcast content in accordance with the received requests as shown in broadcast content receive operation 230 and broadcast content transmit operation 240 of FIG. 2 is described in further detail in method 400 of FIG. 4. Once the request broker 193 transmits the request for broadcast data to the request and content processor for handling, the request and content processor opens a connection, e.g. via TCP/IP, to the appropriate broadcast content loop. Since requests for broadcast data may be received at any time, connections to the broadcast content loop may be opened at any point in the progress of the transmission of the broadcast content. However, the request and content processor observes the data stream and proceeds to initiate retrieval of the broadcast content at the next available access point, as shown in broadcast content retrieval initiation operation 410. The request and content processor may record this access point as a first or starting data point of the data retrieval, as shown in access point recording operation 420. This access point may be recorded using an object variable or pointer value or other data structure as known in the art.

The request and content processor retrieves broadcast content data after the first or starting data or access point has been recorded, as shown in broadcast content retrieval operation 430. At this point the request and content processor may buffer the data as necessary, e.g. in memory 184 until the starting data point of the data retrieval is read in the broadcast data stream. In one embodiment of the invention, broadcast content cache 194, shown in FIG. 1 may be provided for this purpose. When the starting data point of the data retrieval is read for the second time (the first time being the time it was recorded in operation 410), data is no longer read by the request and content processor for this request. The request and content processor assembles and reorders the data in the original transmission order and then transmits this data directly to the client in broadcast content assembly and transmission operation 440. Transmission of the broadcast content to the client 100A is performed preferably via HTTP transmission or other transmission mechanisms known in the art.

In this embodiment of the invention as described in FIG. 4, the broadcast content loop mechanism is completely transparent to the client computer system 100A, aside from the improvement in data access times that may be observed by the client due to one fewer data retrieval operation being executed per data request. The reordering and assembly of the data (e.g. web page content) read from the continuous broadcast loop into the form of a conventional HTTP data retrieval and transmission back to the client is performed at the server. Thus, the data received at the client is in the form of a conventional HTTP transmission, which may be received and displayed at the client 100A via a browser window 195 displayed at monitor 116. In this embodiment, a conventional browser program known in the art, e.g. Netscape Communicator 4.72, may be executed at the client to request and display broadcast web page content.

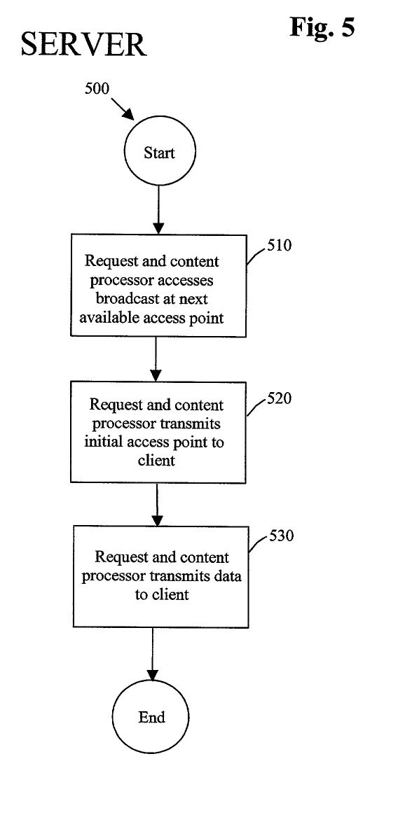

In another embodiment of the invention, shown in FIG. 5, server computer 180 retrieves the broadcast content data and transmits it to the client without reassembling or repackaging the broadcast content in method 500. In broadcast content retrieval initiation operation 510, server computer 180 opens a connection to the broadcast content loop and reads the broadcast content data starting from an initial access point until that initial access point is again accessed, similar to operation 410 of FIG. 4. In access point transmission operation 520, request and content processor 191 executing at server computer 180 transmits initial access point information to the client computer system 100A. Transmission of initial access point information should provide client computer system 101A with information to assist in reassembly of the data in the correct sequential ordering for display by a browser program. However, in another embodiment of the invention, initial access point information may not be needed to assist the client 100A in reordering the broadcast data in the correct sequence and format for display. For example, define access points operation 310 of FIG. 3 may result in sequentially ordered index numbers defined at regular intervals in the web page content data to be broadcast. These index numbers may be embedded in the web page content data to be broadcast, for example as part of a TCP packet header encapsulating the data for transmission from server computer 180 to client computer system 100A. The embedded index numbers may be accessed by client computer system 100A, and used as a guide to sort the data packets in the proper order for display at the client browser window 195.

Server computer 180 then transmits the broadcast content data to the client without repackaging it for immediate display by an HTTP enabled web browser, as shown in broadcast content transmission operation 530. Server computer 180 may transmit the broadcast content data using TCP/IP or any other network communication protocol known in the art.

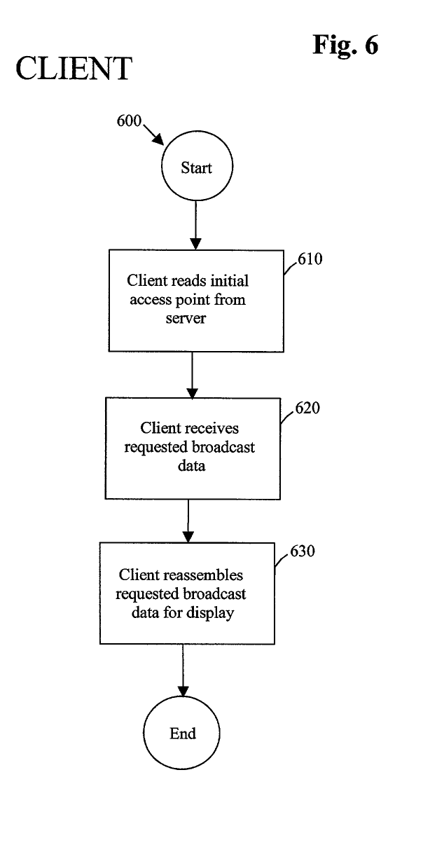

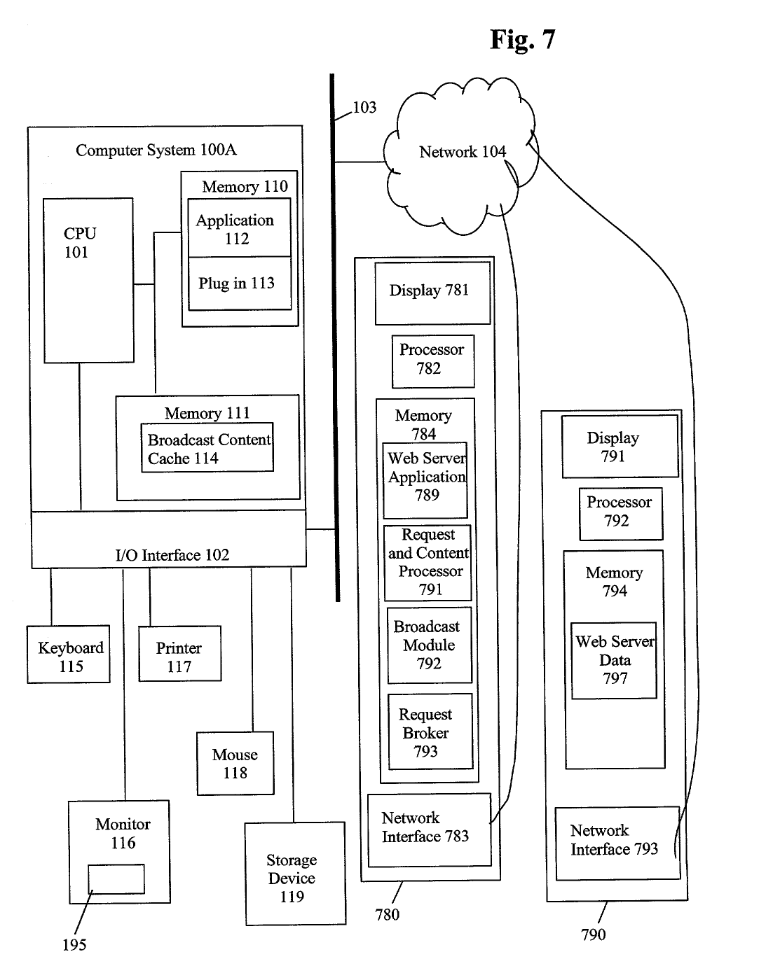

Meanwhile, in the embodiment of the invention discussed above with respect to FIG. 6, client computer system 100A executes corresponding method 600 on CPU 101 as shown in FIG. 7. The execution of client browser application 112, stored in memory 110, may occur in conjunction with plug-in program 113. The execution of plug-in program 113 occurs during execution of client browser application 112. Plug-in program 113 contains additional instructions to perform method 600 and assist server computer 180 in processing web page content received via broadcast for display at browser window 195 on monitor 116.

Executing the instructions contained in plug-in program 113, client 100A reads the initial access point received from the server computer 180, as shown in data point read operation 610. However, as noted above, in alternate embodiments of the invention, the client 100A may not need to execute data point read operation 610, if the broadcast content data is itself sequentially indexed.

Once the client receives the initial access point from the server, the client may then receive the requested broadcast content data, via TCP/IP or any other transmission protocol known in the art, in broadcast content receive operation 620. In one embodiment of the invention shown in FIG. 7, the broadcast content data may be stored in a portion of memory 111 of client computer system 100A, designated here as broadcast content cache 114.

In client broadcast content reassembly operation 630, the client may use the initial access point it recorded in read operation 610 or the index numbers embedded within, e.g. the TCP transmission packets, to reorder the broadcast content into the original order. In this manner, the transmitted content will form a web page document capable of being displayed by a client browser program 112 on browser window 195 of display 116.

### Hardware Overview

The present invention is applicable to a client-server configuration 105A as illustrated schematically in FIG. 1. The computer system 100A may comprise a personal computer or a workstation, and may include a central processing unit 101 coupled to an input output (I/O) unit 102, a first memory 110 and a second memory 111. First memory 110 and second memory 111 may comprise a random access memory (RAM) or other dynamic storage device, and may store information and instructions executed by CPU 101. First memory 110 and second memory 111 may also further be used to store temporary variables or other intermediate information during execution of instructions by CPU 101. Computer system 100A may also include a read only memory (ROM) or other static storage device (not illustrated) which may be coupled to CPU 101 and used for storing static information and instructions to be executed by CPU 101.

Computer system 100A may further include standard input devices like a keyboard 115, including alphanumeric and other keys, a mouse 118, or a speech processing means (not illustrated). A storage device 119, such as a magnetic disk or optical disk, may also be provided and coupled to I/O interface 102 and provides additional storage of information and instructions.

Computer system 100A may also be coupled via I/O interface 102 to a monitor 116, such as a cathode ray tube (CRT) or liquid crystal (LCD) device for displaying information to a computer user, including information displayed via browser window 195.

Herein, a computer program product comprises a medium configured to store or transport computer readable code for methods 200, 300, 400, 500, or 600, or in which computer readable code for methods 200, 300, 400, 500 or 600 are stored. Some examples of computer program products are CD-ROM discs, ROM cards, floppy discs, magnetic tapes, computer hard drives, servers on a network, and signals transmitted over a network representing computer readable program code.

As illustrated in FIGS. 1 and 7, this storage medium may belong to the computer system itself. However, the storage medium may also be removed from the computer system. For example, method 600 may be stored in memory 184 that is physically located in a location different from processor 101. The only requirement is that processor 101 is coupled to the memory. This could be accomplished in a client-server system, or alternatively via a connection to another computer via modems and analog lines, or digital interfaces and a digital carrier line.

For example, memory 184 could be in a World Wide Web portal, while display unit 116, and processor 101 are in personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 100A, in one embodiment, can be a portable telephone, a workstation, a two-way pager, a cellular telephone, a digital wireless telephone, a personal digital assistant, a server computer, an Internet appliance, or any other device that includes the components shown and that can execute method 600, or at least can provide the capability to receive user inputs and to display information requested by the user via a browser program. Similarly, in another embodiment, computer system 100A can be comprised of multiple different computers, wireless devices, cellular telephones, digital telephones, two-way pagers, or personal digital assistants, server computers, or any desired combination of these devices that are interconnected to perform, the methods as described herein.

Herein, a computer memory refers to a volatile memory, a non-volatile memory, or a combination of the two in any one of these devices. Similarly, a computer input device and a display unit refer to the features providing the required functionality to input the information described herein, and to display the information described herein, in any one of the aforementioned or equivalent devices.

In view of this disclosure, methods 200, 300, 400, 500, or 600 can be implemented in a wide variety of computer system configurations. In addition, methods 200-600 could be stored as different modules in memories of different devices. For example, in one embodiment, methods 200, 300, 400, and 500 are stored in memory 184 of system 180 in FIG. 1. In an embodiment of the invention, web server data 190 is also stored in memory 184, and may be accessed for continuous broadcast by broadcast module 192 of FIG. 1.

In one embodiment of the invention, shown in FIG. 7, methods 200, 300, 400 and 500 are stored in memory 784 of system 780. Web server data 797 is stored in memory 794 of server 780, which is connected to network 104, along with server computer 780. Web server data 797 may be accessed for continuous broadcast by server computer 780 executing broadcast module 792.

In another embodiment shown in FIG. 7, method 600 could be stored on a memory 110 of client device 100A. In one embodiment, as shown in FIG. 7, method 600 may be a plug-in program 113 executable in association with application program module 112, where application program module 112 comprises a browser application. Alternatively, method 600 could initially be stored on a memory 184 of a server computer 180, and then as necessary, a module of method 600 could be transferred to a client device 100A and executed on client device 100A. In this embodiment, stored method 600 is transferred over network 104 to memory 111 in system 100A. In this embodiment, network interface 183 and I/O interface 102 would include analog modems, digital modems, or a network interface card. If modems are used, network 104 includes a communications network, and method 600 is downloaded via the communications network. In view of this disclosure, those of skill in the art can implement the invention on a wide variety of physical hardware configurations using an operating system and computer programming language of interest to the user.

Methods 200, 300, 400, and 500 may be implemented as part of a comprehensive web server application program, including but not limited to the APACHE HTTP web server program available from The Apache Software Foundation, and accessible via the Internet at http://www.apache.org. Method 600 may be implemented as a plug-in program module to a browser client application program, such as the NETSCAPE NAVIGATOR and NETSCAPE COMMUNICATOR programs manufactured by Netscape Communications Corporation of Mountain View, Calif. (NETSCAPE NAVIGATOR AND NETSCAPE COMMUNICATOR are trademarks of Netscape Communications Corporation). Methods 200, 300, 400, 500 and 600 may be implemented as part of an object oriented programming system including but not limited to the JAVA programming system manufactured by Sun Microsystems, Inc. of Palo Alto, Calif. (JAVA is a trademark of Sun Microsystems, Inc.).

Such a computer program may be stored on any common data carrier like, for example a floppy disk or a compact disc (CD), as well as on any common computer system's storage facilities like hard disks. Therefore, an embodiment of the present invention also relates to a data carrier for storing a computer program for carrying out the inventive method. Another embodiment of the present invention relates to a computer system for carrying out the presented inventive method. Yet another embodiment of the present invention relates to a computer system with a storage medium on which a computer program for carrying out the presented inventive method is stored.

The term “computer readable medium” as used herein refers to any medium that participates in providing instructions to CPU 101 for execution. Such a medium may take many forms, including a common data carrier or storage medium as discussed above, or other forms of non-volatile media, volatile media, and transmission media. Non-volatile media includes, for example, optical or magnetic disks, such as storage device 119. Volatile media includes dynamic memory, such as memory 111. Transmission media includes coaxial cables, copper wire and fiber optics. Transmission media can also take the form of acoustic or electromagnetic waves, such as those generated during radio-wave, infrared, and optical data communications.

Common forms of computer readable media include, for example, a floppy disk, a flexible disk, hard disk, magnetic tape, or any other magnetic medium, a CD-ROM, any other optical medium, punch cards, paper tape, or any other physical medium with patterns of holes, a RAM, a PROM, an EPROM, a FLASH-EPROM, or any other memory chip or cartridge, a carrier wave as described hereinafter, or any other medium from which a computer can read.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A method in a data processing system for fulfilling data requests, the method comprising:
receiving a data request from a client data processing device;
determining whether the requested data is transmitted via a first continuous broadcast loop, wherein the first continuous broadcast loop includes one or more data points continuously transmitted in order from a start data point to an end data point;
retrieving the requested data, wherein if the requested data is transmitted via a first continuous broadcast loop, retrieving the requested data comprises
opening a use connection to the first continuous broadcast loop;
receiving a complete data transmission from the first continuous broadcast loop;
closing the use connection to the first continuous broadcast loop; and
transmitting the requested data to the client data processing device.

2. The method of claim 1, wherein the complete data transmission comprises data transmitted through the use connection between a first transmission of a first data point on the first continuous broadcast loop and a second transmission of the first data point, and
the first data point may comprise a data point other than the start data point on the first continuous broadcast loop.

3. The method of claim 2, wherein the first data point comprises a marker.

4. The method of claim 2, further comprising:
storing the first data point;
retrieving one or more data points from the continuous broadcast loop, wherein each data point received is compared to the stored first data point; and
closing the use connection when the received data point matches the stored first data point.

5. The method of claim 4, further comprising arranging the retrieved data points in order from the start data point to the end data point.

6. The method of claim 5, wherein the arranging is performed by a plugin program executing at the client.

7. The method of claim 1, wherein the series of data points transmitted by the first continuous broadcast loop comprises a document that may be displayed by a browser program executing at the client data processing device.

8. The method of claim 1, wherein a second continuous broadcast loop is accessed by clicking on a link displayed by a browser program.

9. The method of claim 1, wherein the first and second continuous broadcast loops transmit data using HTTP.

10. The method of claim 1, wherein the data points comprise TCP data packets.

11. A computer system comprising:
a memory having stored thereon a World Wide Web content request processing module;
a processor coupled to said memory, wherein upon execution of said World Wide Web content request processing module by said processor, generating a method comprising:
receiving a data request from a client data processing device;
determining whether the data request is associated with a first continuous broadcast loop, wherein the first continuous broadcast loop includes one or more data points continuously transmitted in order from a start data point to an end data point;
retrieving the requested data, wherein if the requested data is transmitted via a first continuous broadcast loop, retrieving the requested data comprises
opening a use connection to the first continuous broadcast loop;
receiving a complete data transmission from the first continuous broadcast loop;
closing the use connection to the first continuous broadcast loop; and
transmitting the requested data to the client data processing device.

12. The system of claim 11, wherein the complete data transmission comprises data transmitted through the use connection between a first transmission of a first data point on the first continuous broadcast loop and a second transmission of the first data point, and
the first data point may comprise a data point other than the start data point on the first continuous broadcast loop.

13. The system of claim 12, wherein the first data point comprises a flag value.

14. The system of claim 12, wherein the requested data is read from the continuous broadcast loop by
storing the first data point;
retrieving one or more data points from the continuous broadcast loop, wherein each data point received is compared to the stored first data point; and
closing the use connection when the received data point matches the stored first data point.

15. The system of claim 14, wherein the requested data comprises the retrieved data points, wherein the retrieved data points are arranged in order from the start data point to the end data point.

16. The system of claim 15, further comprising a plugin program executing at the client, wherein the plugin program arranges the retrieved data points of the requested data in order from the start data point to the end data point.

17. The system of claim 11, wherein the series of data points transmitted by the first continuous broadcast loop comprises a document that may be displayed by a browser program executing at the client data processing device.

18. The system of claim 11, wherein a second continuous broadcast loop is accessed by clicking on a link displayed by a browser program.

19. The system of claim 11, wherein the first and second continuous broadcast loops transmit data using HTTP.

20. The system of claim 11, wherein the data points comprise TCP data packets.

21. A system comprising:
means for receiving a data request from a client data processing device;
means for determining whether the requested data is transmitted via a first continuous broadcast loop, wherein the first continuous broadcast loop includes one or more data points continuously transmitted in order from a start data point to an end data point;
means for retrieving the requested data, wherein if the requested data is transmitted via a first continuous broadcast loop, retrieving the requested data comprises
opening a use connection to the first continuous broadcast loop;
receiving a complete data transmission from the first continuous broadcast loop;
closing the use connection to the first continuous broadcast loop; and
transmitting the requested data to the client data processing device.

22. A computer-readable medium containing instructions that cause a data processing system to perform a method for fulfilling data requests, the method comprising:
receiving a data request from a client data processing device;
determining whether the requested data is transmitted via a first continuous broadcast loop, wherein the first continuous broadcast loop includes one or more data points continuously transmitted in order from a start data point to an end data point;
retrieving the requested data, wherein if the requested data is transmitted via a first continuous broadcast loop, retrieving the requested data comprises
opening a use connection to the first continuous broadcast loop;
receiving a complete data transmission from the first continuous broadcast loop;
closing the use connection to the first continuous broadcast loop; and
transmitting the requested data to the client data processing device.

23. A computer program product having stored thereon a method for broadcasting World Wide Web content data, the method comprising:
receiving a data request from a client data processing device;
determining whether the requested data is transmitted via a first continuous broadcast loop, wherein the first continuous broadcast loop includes one or more data points continuously transmitted in order from a start data point to an end data point;
retrieving the requested data, wherein if the requested data is transmitted via a first continuous broadcast loop, retrieving the requested data comprises
opening a use connection to the first continuous broadcast loop;
receiving a complete data transmission from the first continuous broadcast loop;
closing the use connection to the first continuous broadcast loop; and
transmitting the requested data to the client data processing device.
